(19) United States
(12) Patent Application Publication
(10) Pub. No.: US 2017/0194789 A1
(43) Pub. Date: Jul. 6, 2017

(54) ENERGY MANAGEMENT SYSTEM

(71) Applicant: KOOL KONCEPTS LIMITED, Hong Kong (CN)

(72) Inventors: Andrew Yuen Chin CHEN, Hong Kong (CN); Amy Decem CHENG, Hong Kong (CN); Tsz Kai TAM, Hong Kong (CN)

(21) Appl. No.: 15/375,156

(22) Filed: Dec. 11, 2016

Related U.S. Application Data
(63) Continuation of application No. 14/209,446, filed on Mar. 13, 2014, now abandoned.
Application No. 14/209,446 is a continuation-in-part of application No. PCT/IB2012/055082, filed on Sep. 24, 2012.
(60) Provisional application No. 61/786,173, filed on Mar. 14, 2013.
(60) Provisional application No. 61/538,806, filed on Sep. 24, 2011.

(51) Int. Cl. H02J 3/14; G08C 17/02; H01R 25/00; H02J 13/00; H01R 13/66; H04Q 9/00; G05B 15/02

(52) U.S. Cl. CPC H02J 3/14; H04Q 9/00; G08C 17/02; G05B 15/02; H02J 13/0017; H01R 13/6683; H01R 25/003; H04Q 2209/60; G08C 2201/50; H02J 2003/143

(57) ABSTRACT

The present invention provides an Energy Management System which can be configured to automatically switch peripheral appliances on or off by detecting master appliances being in standby state, even though these appliances are located far away from each other in a premise, or even in other premises. The system is also capable of detecting whether the included appliances are plugged or unplugged to facilitate simple and efficient management of appliance power consumption for the sake of energy saving. In one embodiment, it also provides a detachable, battery-powered wireless sub-system, supporting dual operation modes, to improve wireless coverage of the system.

### FIELD OF THE INVENTION

The present invention relates generally to systems for the automation of monitoring and controlling electrical appliances to reduce energy consumption and increase energy efficiency for households, offices and institutions.

### BACKGROUND OF THE INVENTION

An energy management system can be a smart meter, a power measuring AC socket, a remote controlled AC socket, a smart power strip, a smart home system, or a campus wide energy management system through network control and monitoring.

A smart meter is a household electricity meter which also has a communication sub-system to provide usage, instant or monthly, to the utility facility for billing and supply planning purposes. It creates a dynamic two-way dialogue between utilities and their customers. This dialogue aims to drive energy efficiency and demand response. Examples available on the market are TENDRIL. The electricity power consumption is a cumulated total per household.

A power measuring AC socket is usually an add-on device, which is inserted between an ordinary AC socket and an appliance under measurement. The device measures the electricity power getting through from the ordinary AC socket to the appliance. The measurement results are usually shown on the display associated on the device. With these results, users can understand how much electricity a particular appliance consumes at any operation modes. Further usage plans can be decided by the users to facilitate energy saving. An example available in the market is Kill-A-Watt.

A remotely controlled AC socket is usually an add-on device, which is inserted between an ordinary AC socket and an appliance. The device usually contains a switch to turn on or off the mains power to the appliance. The device can be controlled remotely through various technologies, such as infra-red, radio frequency wave, power-line signal and so on. Some of the technologies, like modem, router, and the Internet, allow the extension of the control far away from the premises, where the device and the appliance are installed. With this device, the usage of the appliance can therefore be managed remotely to improve energy utilization. An example available in the market is Wayne Dalton.

A smart power strip is an extension of AC sockets, which are usually divided into two kinds, namely master and peripheral. Electric power consumption of the master socket is being monitored. When the appliance plugged into the master socket consumes power less than a threshold (standby power), those peripheral sockets will be switched off automatically to cut further power consumption. On the contrary, when the master socket draws power higher than the threshold (re-activated to normal), those peripheral sockets will be turned on automatically. For example, a computer is plugged into the master socket, while the associated monitor, printer, router, speaker are in the peripheral sockets. Examples available on the market are IntelliPanel and BuLogics.

A smart home system is usually a home wide network which complies of devices such as light switches, AC sockets, door locks, room temperature conditioning thermostat, remote controllers, and so on. Examples available in the market are HAI, EnergyHub and Energate. These devices communicate with each other to form a network, and the networking media can be radio frequency, infra-red, or power-line. These systems mainly address home control automation. Though some of the devices include the power measurement feature, there is usually no proactive energy saving schemes for users to save energy.

A campus wide energy management system utilizes network infrastructure to link up various sub-systems such as power measuring AC sockets and remotely controlled AC sockets, which are installed throughout the campus, which is usually divided into small areas of clusters to facilitate management and operations. A control centre will review the energy usage and control appliance individually or cluster-wise, in order to better utilize the energy consumption. Examples of this system are Cisco's EnergyWise and Agilewaves.

However, each of the above energy management devices has its weakness. For example, the smart meter reports a total electricity usage per household. There is no idea which individual appliance consumes more. This makes energy management difficult and inefficient. The power measuring AC socket tells how much an appliance consumes, but will not proactively help the users about energy saving. Similarly, the remotely controlled AC socket needs users' intervention to switch off so as to save energy. On the contrary, the smart power strip is actively helping users to save energy, as it measures the master appliance and switches off the peripherals automatically. The only drawback is that the master and its peripherals have to be plugged on the same smart strip. A campus wide energy management system is the most complete and automatic solution, but the implementation complexity, equipment cost, maintenance works will overwhelm the benefit of energy saved for a household user.

### SUMMARY OF THE INVENTION

The present invention provides a system, which measures the power consumption of each appliance plugged in the system, and is able to remotely switch on or off any appliance plugged in the system. In one embodiment, the software application can be configured to proactively and automatically manage one or many peripheral appliances to switch on or off based on the power consumption of one or many master appliances. These master and peripheral appliances are not necessary to be plugged on the same power strip. For example, a configuration can be set to have an Internet router (in living room) and a laser printer (in study room) automatically switched off when all computers (in study room and bedrooms) have been consuming standby power only. In another embodiment, when a plurality of the system are implemented in multiple premises, the master and peripheral appliances can even be located in any physical locations around the world. For example, a video storage network shared hard drive a company's headquarter) can be automatically switched when the associated computers (in regional sales offices) are all in standby or off.

The invention also provides appliance plugged and unplugged detection and notification to the users. Since all the appliances in the system will be monitored and controlled, the correct identification of each appliance is important. This detection and notification is to identify new appliance joining the system, to update the configuration if an appliance has been migrated from one AC socket to another in the system.

Features are designed to provide minimal effort and less intervention required by the users to maintain effective and efficient energy saving.

Sensitive and valuable appliances are usually protected by surge arrestors. In one embodiment, the present invention not only provides appliances with a conventional surge arrestor, but also an arrestor failure detection scheme. Once a failure is detected, a push notification will immediately notify the users, e.g. via a smart phone app with a plurality of users registered with the system. Those users can take immediate actions to tackle the outage to guarantee the service.

In one embodiment, the Energy Management System of the present invention is a home- or office-wide network comprising a single Master Device, together with a plurality of Slave Devices. Each of the Slave Device is capable of remote controlling and energy measuring over multiple home or office appliances, such as TV, computers, game consoles, ovens, washing machines, lighting and so on. They communicate wirelessly with the Master Device, which then communicate wirelessly with computers and portable devices, such as smart phones or tablet PCs. The software, or apps, runs on computers or portable devices provides a user interface to manage the energy measurement data and control of those connected appliances. Through modems, routers, and the Internet service providers, the measurement and control can be accessed remotely, even when the user is not at the location where the appliances are located.

In one embodiment, the Slave Device functions as an ordinary power strip (see FIG. 2). It also has the feature of a smart strip. The Slave Device does not classify its AC sockets into master nor peripheral. Since each of the AC sockets on the Slave Device is capable of both power measurement and remote controlling, either a master or peripheral appliance can be plugged into the AC socket depending on system configuration through the software application on computers, or apps on smart phones or tablet PC. Therefore, the invention extends the smart strip feature not limited to one Slave Device, it can be across multiple Slave Devices. That is the master appliance can be on one Slave Device, but the associated peripherals can be on any other Slave Devices wirelessly linked together.

In one embodiment, the Master Device (see FIG. 3) not only has the same functions as the Slave Device, but also includes a detachable Dongle (see FIG. 4), a docking space for the Dongle, and a battery charging circuitry for the Dongle. In one embodiment, the Dongle comprises an industrial standard module which translates the power measurement data and remote control instructions to and from the Master or Slave Devices to be accepted by computers, smart phones and tablet PC which support the Wi-Fi feature, so that PC software and apps can be utilized to control the appliances and to analyze the data through a user friendly and interactive interface, instead of just a traditional button driven remote controller that is almost unable to upgrade with new features in the future. Currently, some home or office automation systems also have similar Wi-Fi translation to allow the use of Wi-Fi enabled computers, smart phones or tablet PC to take the control. However, they join the existing Wi-Fi network. The present invention, in contrast, is capable of creating a new Wi-Fi network if there is no existing Wi-Fi network. Alternatively, the system of the present invention would provide a Wi-Fi network that can cover some blind spots where the computers, smart phones or tablet PC are located. In one embodiment, the Dongle is rechargeable battery powered, so it is portable to minimize the chance of having Wi-Fi blind spots.

In another embodiment, in order to further improve user friendliness, every AC socket in the Master and Slave Devices will have a plug detection feature. Whenever an appliance has been plugged or unplugged, the user will be notified through the computer software or apps. Therefore, the user will have an immediate notification of unsecured plug insertion, or incorrect plug removal. This can protect major appliances to operate properly.

### BRIEF DESCRIPTION OF THE FIGURES

The accompanying drawings which are incorporated into and constitute a part of this specification illustrate one or more embodiments of the present invention and together with the detailed description serve to explain the principles and implementations of the invention.

FIG. 1a shows a connectivity overview of one embodiment of the present Energy Management System.

FIG. 1b shows a connectivity overview of one embodiment of a plurality of the present Energy Management System installed in multiple premises.

FIG. 2 shows an illustration for one embodiment of a power measurement device, the Slave Device.

FIG. 3 shows an illustration e embodiment of a power measurement device, the Master Device.

FIG. 4 shows an illustration for one embodiment of the Dongle.

FIG. 5 shows a schematic diagram for one embodiment of the Dongle.

FIG. 6 shows one embodiment of the software state diagram for the Dongle.

FIG. 7 shows a schematic diagram for one embodiment of the Slave device.

FIG. 8 shows one embodiment of the software state diagram for the Slave device.

FIG. 9 shows one embodiment of the operational state diagram for the internet server.

FIG. 10 shows one experimental setup of the present System.

FIG. 11 shows the energy measurement result of a hot and cold distilled water dispenser.

FIG. 12 shows the energy measurement results of three desktop computers and one notebook computer.

FIG. 13 shows the energy measurement results of a water dispenser in a pantry and a desktop computer in an office room. They are both connected to the System under control and monitoring, but are separated far apart and do not share the same Master/Slave device.

### DETAILED DESCRIPTION OF THE INVENTION

The present invention, the Energy Management System is a network system for household, offices or institutions, comprising a Dongle together with a plurality of Power Measurement Devices.

### Definitions and Abbreviations

AC—alternating current power delivered from the electricity utilities to the household.

Dongle—is a proprietary hardware. In one embodiment, it includes three communication modules, namely Wi-Fi, Z-Wave and USB. There is a micro-controller with proprietary software to connect these modules and to relay signals among each other.

Master Appliances—appliances for which their power consumption will be monitored, and one or more peripheral appliances will be switched on or off depending on the power consumption of the master appliances.

Master Device—functions same as a Slave Device. In one embodiment, it includes a detachable Dongle and an additional docking and charging space for the Dongle.

Peripheral Appliances—appliances for which their power will be switched on or off depending on power consumption of the master appliances.

RF—a frequency or band of frequencies that can be used for radio communications and broadcasting.

Slave Device—a proprietary hardware functioning like a power strip. In one embodiment, it includes a Z-Wave module, an energy measurement system, and a micro-controller with proprietary software. It can communicate wirelessly with the Dongle to exchange energy measurement data and other control data.

Smart phone—may be thought of as handheld computers integrated within a mobile telephone; a smart phone usually allows the user to install and run more advanced applications.

SSID—service set identifier (SSID) is a name that identifies a particular 802.11 wireless LAN (also known as Wi-Fi).

Tablet PC—is a notebook or slate-shaped mobile computer; refers to computer-like devices operated primarily by a touch screen.

USB—is an industry standard developed in the mid-1990s that defines the cables, connectors and communications protocols used in a bus for connection, communication and power supply between computers and electronic devices.

Wi-Fi—is a mechanism for wirelessly connecting electronic devices. A device enabled with Wi-Fi, such as a personal computer, video game console, smart phone, or digital audio player, can connect to the Internet via a wireless network access point.

Z-Wave—is a standard in wireless remote control using low power radio waves.

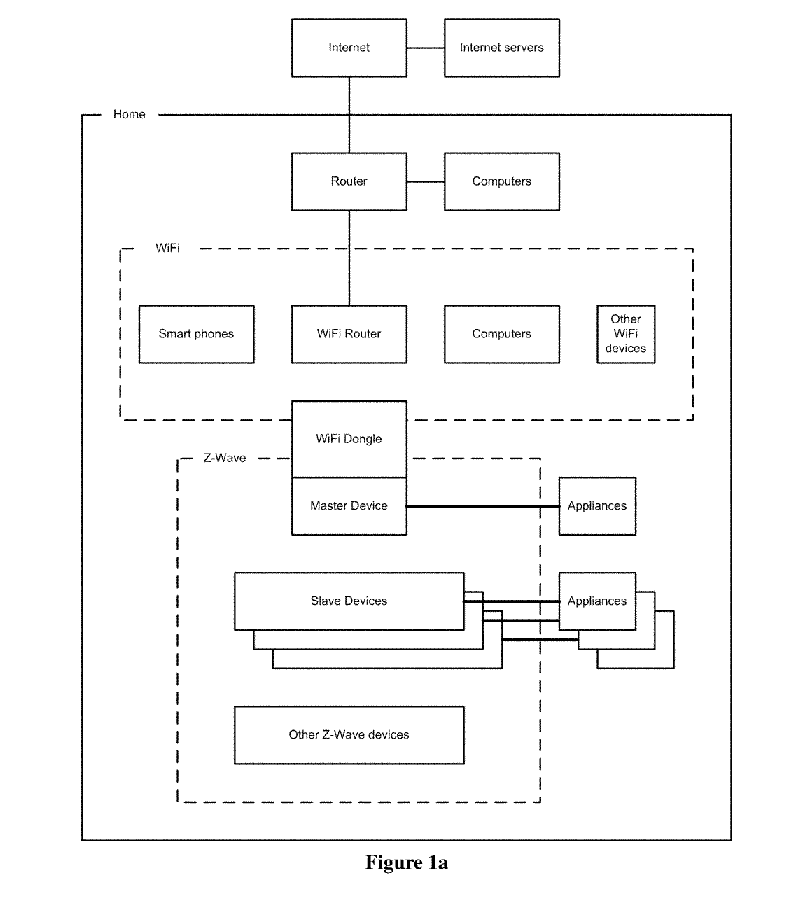

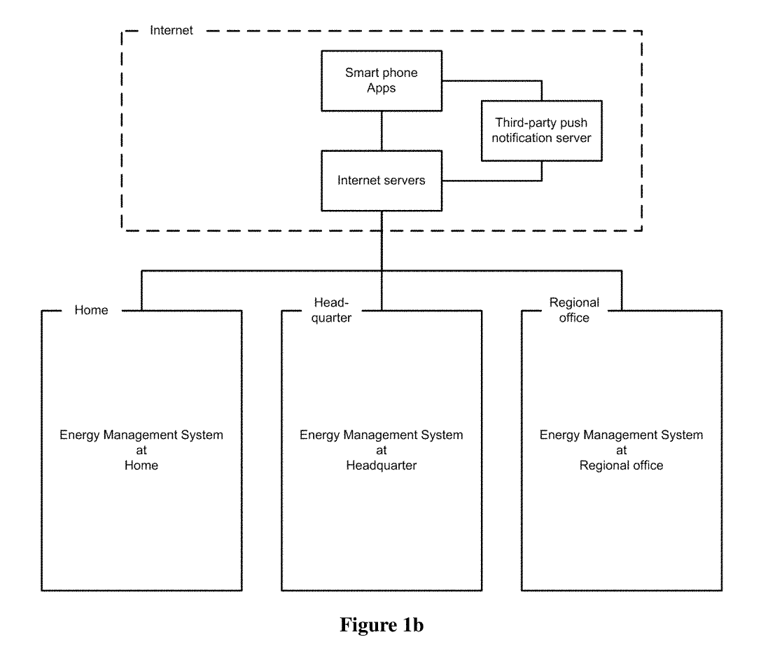

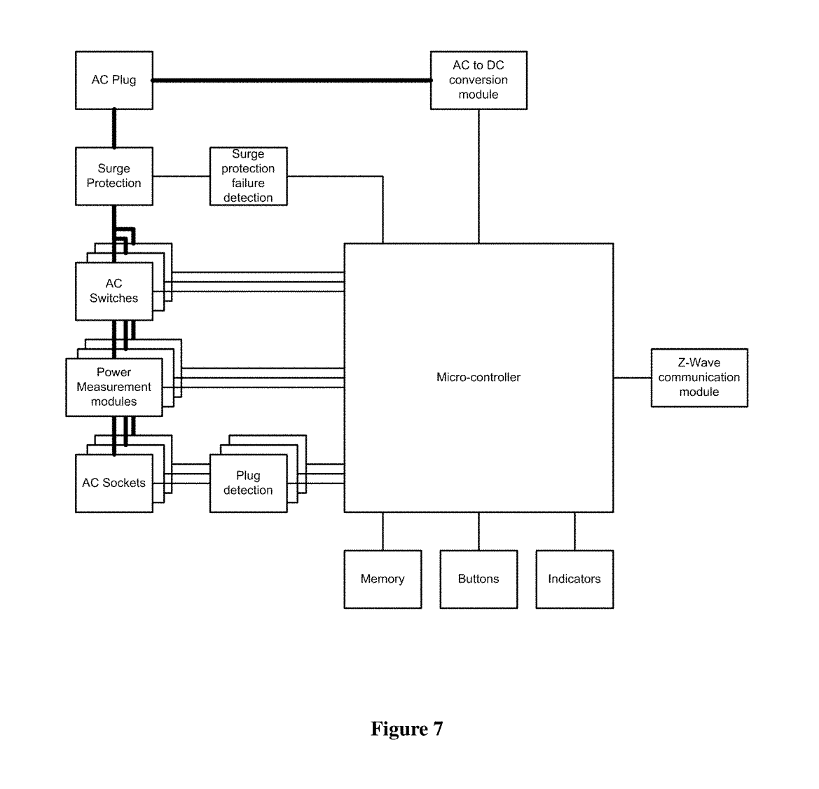

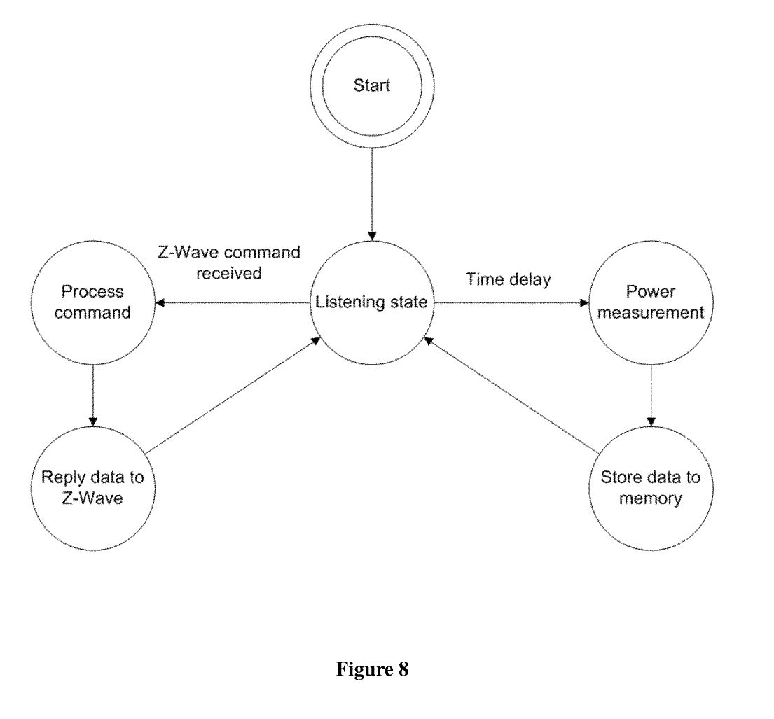

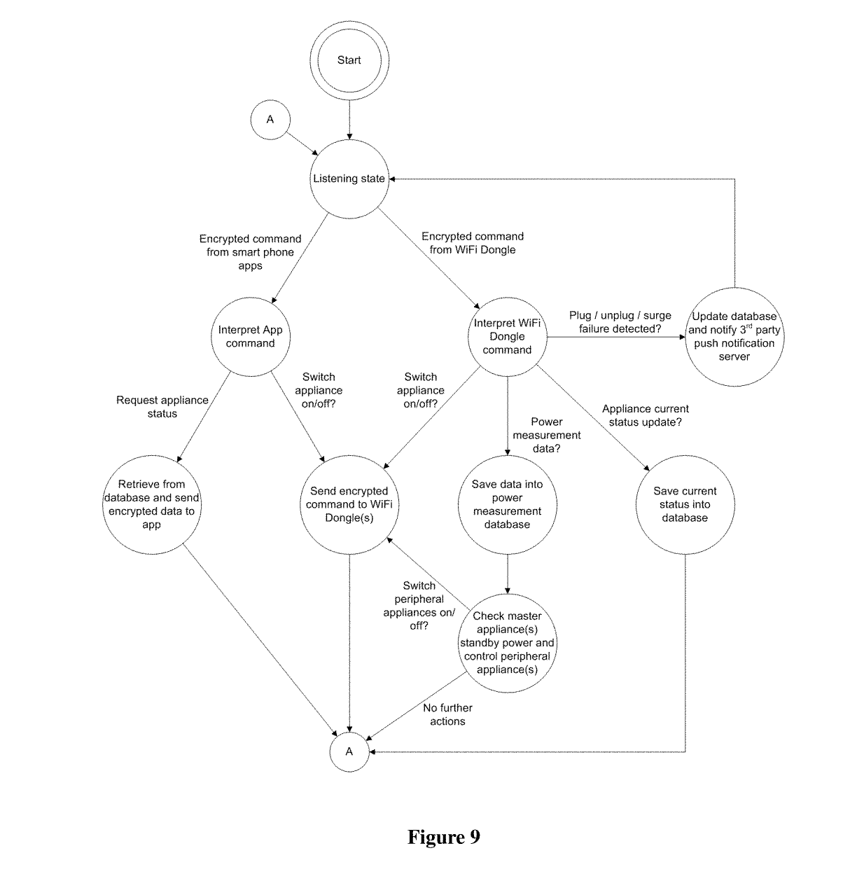

In one embodiment, the power measurement device as shown in FIG. 2 has a similar construction as an ordinary power strip. It has an AC plug to acquire electrical power, and can be designed to have a plurality of AC sockets to deliver electricity for any appliances plugged on it. Each of the AC sockets is associated with an electronic circuitry to measure the electrical power and an electronic switch to control the power on or off. Power measurement data will be stored in memory, for a period of time until the memory is full. In addition, there is a wireless communication module in the power measurement device for the control and data signal exchange with a Master Device or a Dongle. In one embodiment, Z-Wave wireless communication module is used. Other wireless protocols generally known in the art, such as ZigBee can also be used. When it is wirelessly connected to a Master Device or a Dongle, the data can be transferred to computers, portable devices or Internet servers for analysis. In one embodiment, the operational state diagram of the Internet server is shown in FIG. 9. However, a power measurement device (the Slave Device) can operate, measure, and store data alone, without the Master Device. In one embodiment, FIG. 1a illustrates the connectivity diagram of the installation of the Master Device, the Slave Device and the WiFi Dongle inside a home environment. Those appliances connected to the Master and Slave Devices are to be controlled and analyzed. The Internet servers are connected to our system through the user's home WiFi router and internet router facilities. In one embodiment, FIG. 7 and FIG. 8 illustrate the block diagram of the circuitry and the software state diagram of the Slave Device respectively.

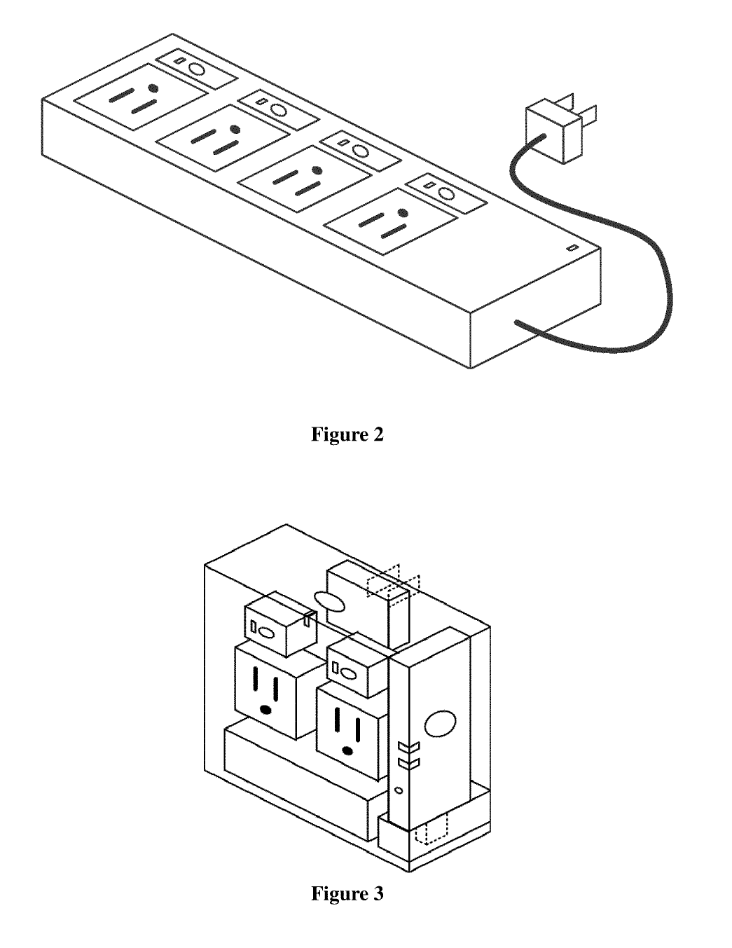

In one embodiment, the Master Device as shown in FIG. 3 not only has the same functions as the Slave Device, but also includes a detachable Dongle, a docking space for the Dongle, and a battery charging circuitry for the Dongle. In one embodiment, the Master device can operate as a single separate device without any slave devices.

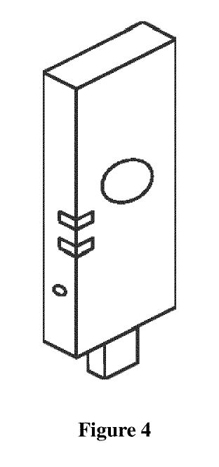

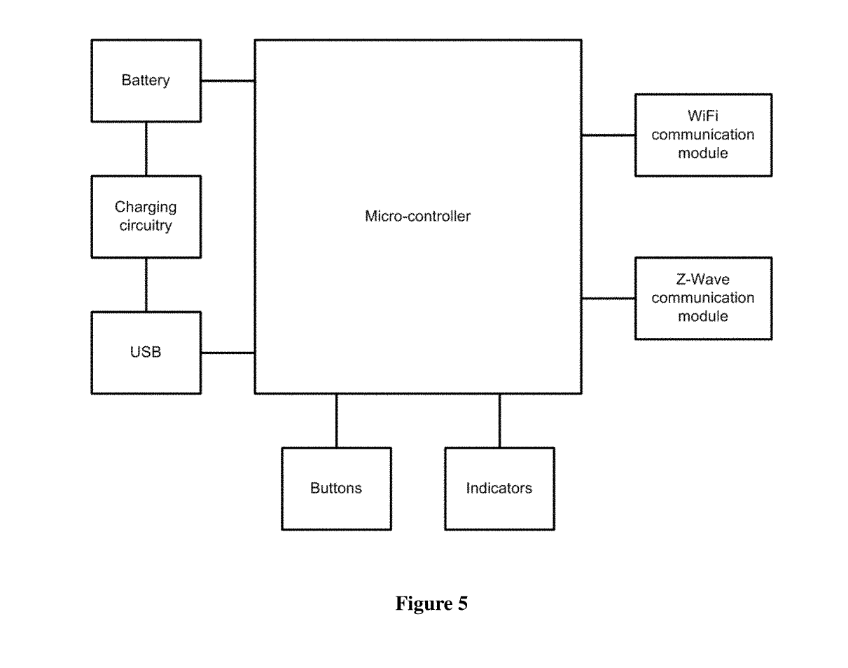

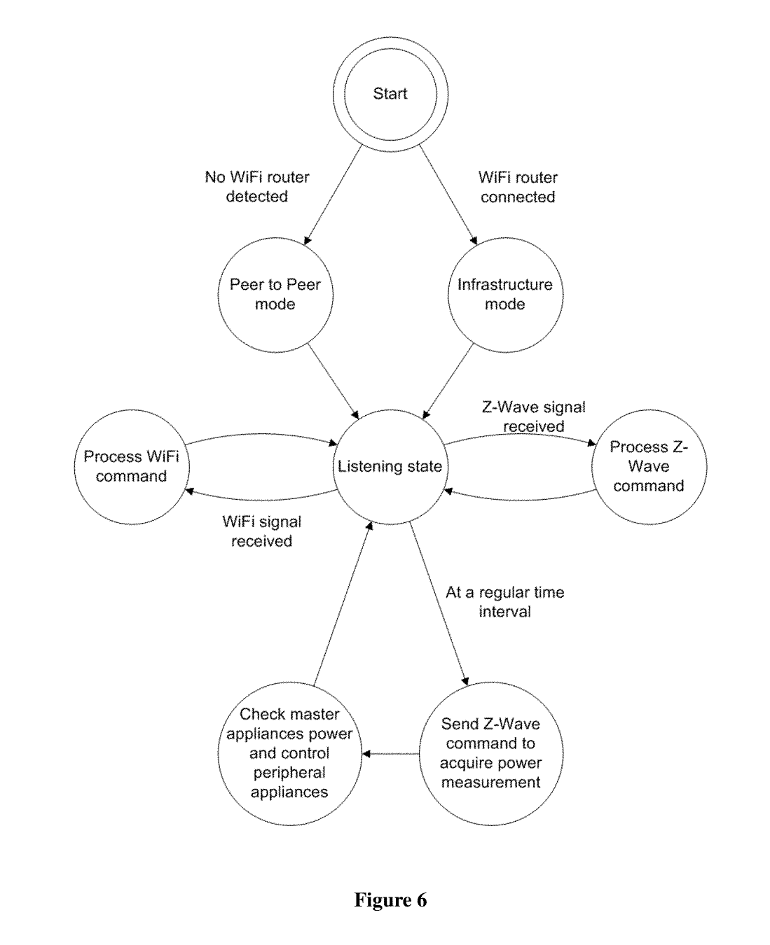

In one embodiment, the Dongle as shown in FIG. 4 includes a Z-Wave wireless communication module as well as an industrial standard Wi-Fi module which translates the power measurement data and remote control instructions to and from the Master or Slave Devices to be accepted by computers, smart phones and tablet PC which support the Wi-Fi feature. There is a built-in rechargeable battery to power the Dongle. Besides, there is a standard USB connector to allow direct communication with computers through the USB bus. The battery charging is also supported through the USB bus power from this USB connection. FIG. 5 and FIG. 6 illustrate the block diagram of the circuitry and the software state diagram of the Dongle respectively.

In one embodiment, the Dongle supports two operating modes offered by the Wi-Fi standard, namely ad-hoc and infrastructure modes. The ad-hoc is a peer-to-peer mode. It operates solely and directly between the Master Device and the computers, smart phones, or tablet PC. On the contrary, the infrastructure mode involves a third party wireless router as a central hub to route data traffic among the Master Device, computers, smart phones, tablet PC, as well as the Internet which allows remote access away from home. Any wireless system, including Wi-Fi, has a coverage problem or blind spots caused by long distance, walls attenuation, or interference. To solve this shortcoming, the Dongle (with the Vs module) can be detached from the Master Device. The battery powered Dongle can then be brought close to the blind spots, and switched to ad-hoc (peer-to-peer) mode so as to directly communicate with the computers, smart phones, or tablet PC to solve the coverage problem. Moreover, if there is no existing home or office Wi-Fi network, the present System is capable of using the ad-hoc mode to create a new Wi-Fi network. In addition, prior to using the infrastructure mode, the ad-hoc mode is used to pass the Wi-Fi authentication information, such as SSW and password, to the Dongle.

After Wi-Fi authentication, the Wi-Fi module on the Dongle can be linked up with a software application on computers, smart phones or tablet PC. When the Master or Slave Device is plugged into the AC mains, it will notify the Dongle wirelessly and the Dongle will update the software application via Wi-Fi. The location of this Master or Slave Device (such as kitchen or bedroom) will be prompted by the software application.

In one embodiment, there is a plug and unplug detection mechanism, by either mechanical or optical mean, implemented to each AC socket of the Master or Slave Device to check the presence of an AC plug to the socket. When an appliance has been plugged into the Master or Slave Device, a similar wireless process will notify the software application to prompt for a name (such as TV or computer) for this newly included appliance.

Sensitive and valuable appliances are usually protected by surge arrestors. When there is a lightning, the arrestor absorbs the over-voltage energy to prevent the appliance from damage. However, when the energy absorbed by the arrestor is larger than that it can sustain, the arrestor will fail and usually a fuse will be tripped to disconnect the appliance from the mains, but the outage may not be observed by users. In one embodiment, is the system of the present invention not only provides a conventional surge arrestor, but also an arrestor comprising failure detection scheme. Once a failure is detected, the Slave Device will immediately notify the WiFi Dongle, and then the Internet Server. The server will send a message to a third-party push notification server (for example, a smart phone system provider), then a push notification will immediately notify a smart phone app with a plurality of users registered with the system. Those users can take immediate actions to tackle the outage to guarantee the service.

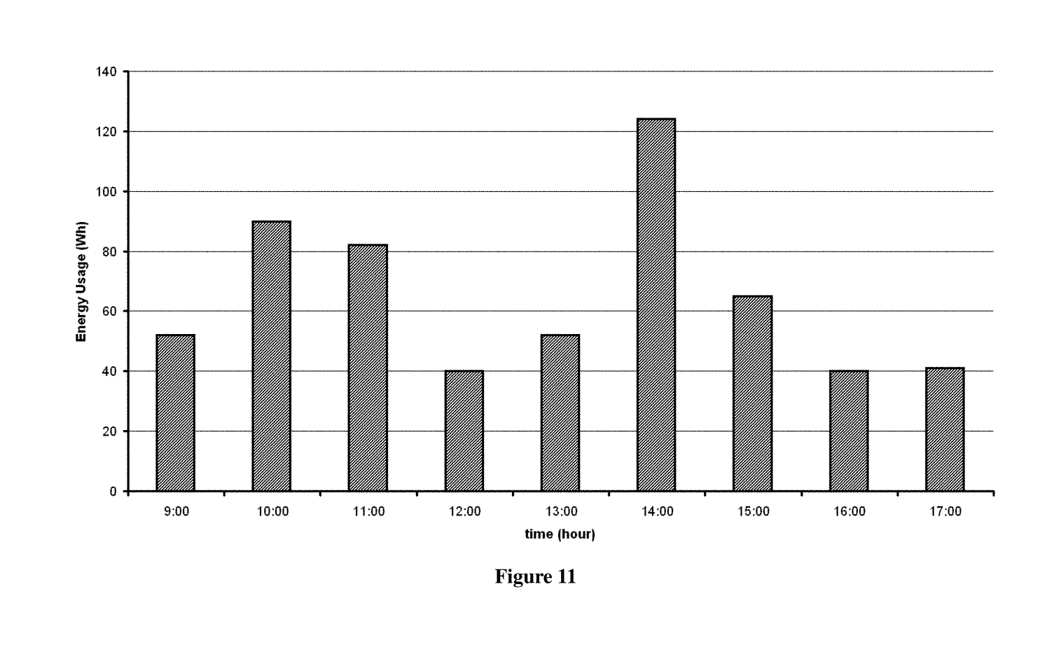

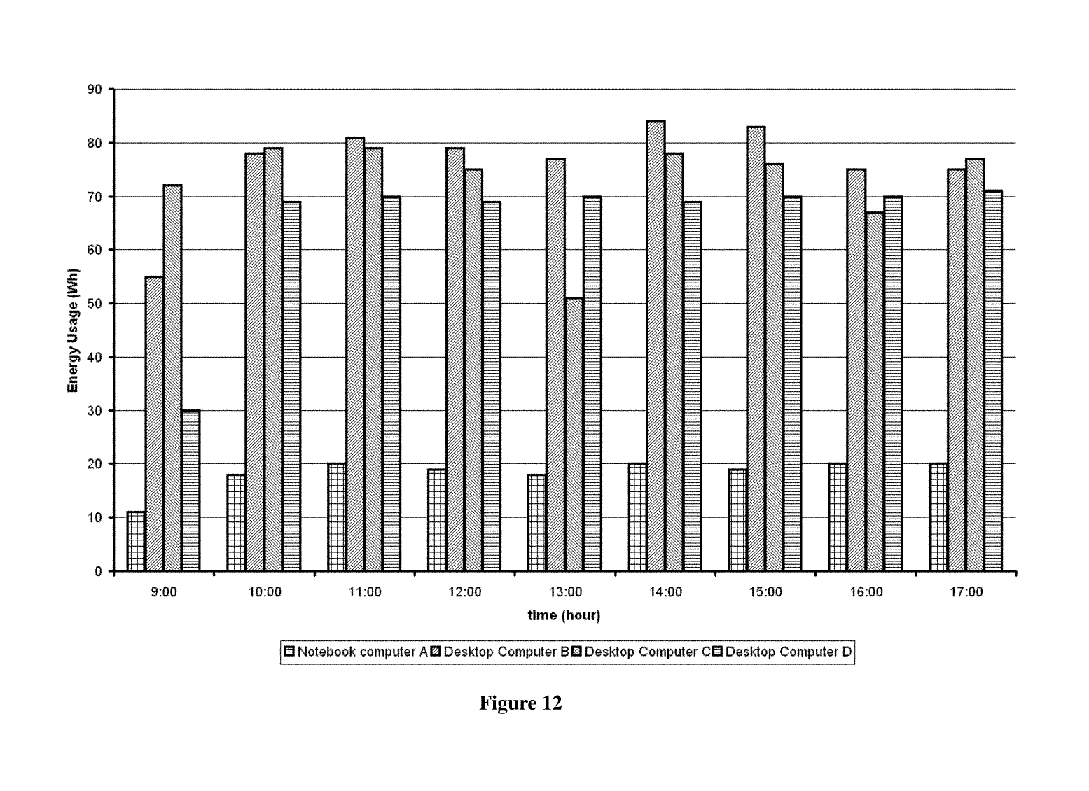

In one embodiment, the software application provides a user interface to display the power measurement and on/off status for each appliance in the system. Each appliance can be switched on or off through the software application remotely. The instantaneous power and the power consumption history in the past can also be retrieved to display through the software application. Analysis can also be made to provide graphical power usage per minute, per hour, per day, per week, per month, or per year to review the usage pattern of an individual appliance (see e.g. FIG. 11 & FIG. 12). In another embodiment, power usage per location, such as living room, kitchen, or bedroom can be made. Power usage per category, such as computer & peripherals, TV & Hi-Fi, can also be consolidated. With the electricity usage information collected from most of the appliances, a summary report of usage pattern, temporal distribution, break-down by areas (e.g. rooms) and categories can be generated for review. Corresponding target saving plans can be optimized to any individual area, category or appliance. Electricity consumption can thus be reduced accordingly.

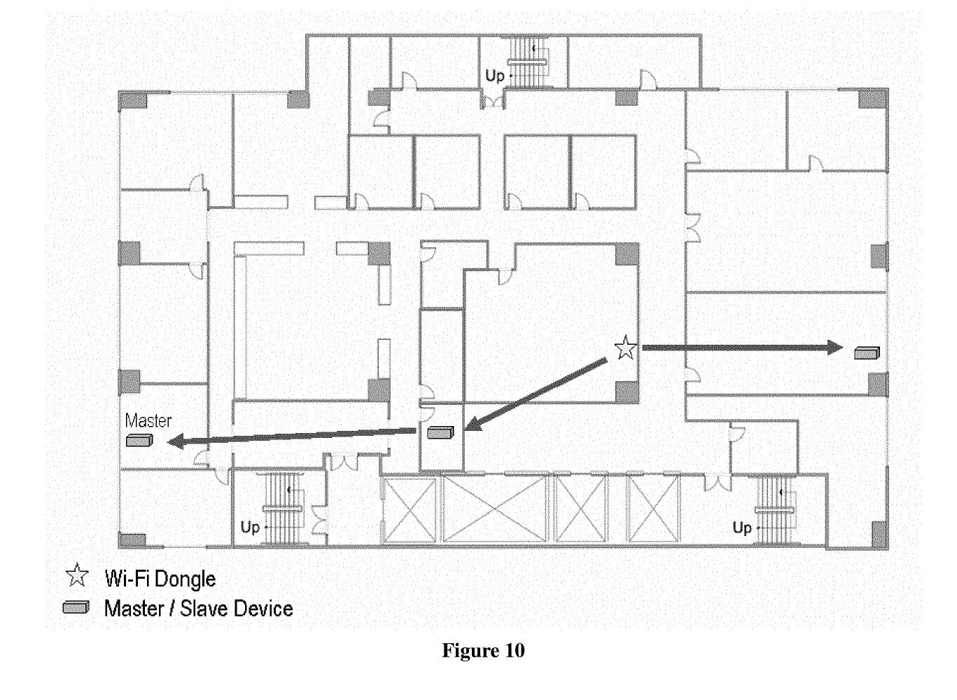

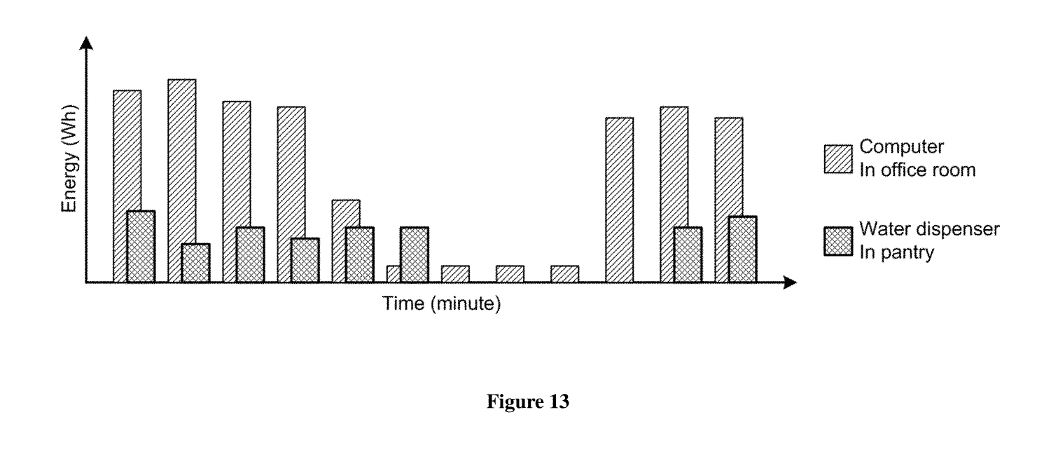

As each of the appliance has its unique identification name, a plurality of appliances can be grouped as master, for which their power will be monitored. Another plurality of appliances can be grouped as peripheral, for which their power will be switched on or off automatically depending on the power measured from the master group. The appliances, no matter the master or the peripheral groups, can be plugged in the Master Device, or any other Slave Devices separated anywhere at home or office (see e.g. FIG. 10). For example, a configuration can be set to have a hot &. cold distilled water dispenser (in pantry) automatically switched off when all computers in an office room are consuming standby power only (see e.g. FIG. 13). This is to provide minimal effort and less intervention required by the users to maintain effective and efficient energy saving.

When any of the included appliance is unplugged, the unplug detection mechanism will be triggered to notify the software application. Then the user will be prompted to confirm if this is intended to do so. This is to avoid improper plug insertion and wrong plug disconnection.

In one embodiment, the present invention provides an Energy Management system capable of determining one or a plurality of primary or master electrical appliances being in standby state, and then automatically switches off a plurality of user defined peripheral appliances across different Slave Devices located in different locations. In reverse, when the primary appliance resumes in operation, those peripheral appliances are switched on automatically.

When a plurality of the system are implemented in multiple premises, the master and peripheral appliances can be separated widely at any physical locations around the world, provided they are all connected to the Internet. For example, a video storage network shared hard drive (in a company's headquarter) can be automatically switched when the associated computers (in regional sales offices) are all in standby or off. FIG. 1b illustrates another example of the connectivity of the system installed in 3 different locations.

In one embodiment, there is provided an energy management system comprising (i) a first power measurement device comprising (1) a plug, (2) one or more power measurement module, (3) one or more AC sockets each of which is coupled with an AC switch, (4) one or more communication modules and (5) a microcontroller, wherein said microcontroller controls the AC switches; (ii) a second power measurement device comprising a plug, a docking space and one or more detachable communication devices, wherein said detachable communication device comprises a microcontroller, one or more communication modules, a charging circuitry and battery; and (iii) one or more computing devices, wherein said computing device comprises a software for analyzing energy consumption measurement and providing control instructions for controlling the energy consumption of the AC sockets, wherein energy consumption from the AC sockets are measured by the first power measurement device and communicated to the computing devices via the communication device of the second power measurement device, wherein control instructions from the computing devices are communicated to the microcontroller in the first power measurement device via the communication device of the second power measurement device.

In one embodiment, the first and second power measurement devices are combined in a single device. In another embodiment, the AC sockets further comprise a surge arrestor failure detection scheme so that a remote user could be notified when the arrestor protection has been failed or tripped.

In one embodiment, the above-mentioned detachable communication device could operate on battery when separated from the second power measurement device. In another embodiment, the communication device of the second power measurement device communicates wirelessly with said computing device using Wi-Fi. In another embodiment, the communication device of the second power measurement device is capable of operating under Wi-Fi in both infrastructure and ad-hoc modes. For example, wherein under ad-hoc mode, the computing device can communicate with the communication device of the second power measurement device from anywhere in the world having Internet connection. In yet another embodiment, the second power measurement device communicates wirelessly with the first power measurement device using Z-Wave or ZigBee wireless communication.

In one embodiment, the computing device of the above energy management system can be a smart phone, a tablet computer, a desktop computer or a notebook computer. In one embodiment, the computing device can store the energy consumption measurement data from each AC socket in the system.

In one embodiment, each of the AC sockets of the above energy management system further comprises a mechanical or optical plug detection mechanism so that a user would be notified through said software when said sockets are plugged or unplugged.

The present invention also provides a method for energy management, comprising the steps: (i) placing the first and second power measurement devices from one or more of the above energy management systems at desired locations; (ii) plugging a plurality of electrical appliances into the AC sockets in the energy management systems; (iii) connecting the first power measurement device, the second power measurement device and the computing device wirelessly; and (iv) designating the electrical appliances as master electrical appliances or peripheral electrical appliances, wherein the peripheral electrical appliances are controlled according to energy consumption of the master electrical appliances. In one embodiment, the first power measurement device and second power measurement device are or are not placed at a same location. In another embodiment, the master electrical appliances and peripheral electrical appliances are or are not plugged into the AC sockets of the same first power measurement device. In yet another embodiment, the master electrical appliances and peripheral electrical appliances are or are not plugged into the AC sockets in the same energy management system.

In one embodiment of the above method, the peripheral electrical appliances are turned off when the energy consumption of a master electrical appliance is lower than its operational need. In another embodiment, the peripheral electrical appliances are automatically turned on when the energy consumption of a master electrical appliance is at its operational need.

In one embodiment, step (iii) of the above method further comprises detaching the detachable communication device from the second power measurement device and placing it at a location which bridges the wireless connection.

Although a detailed description of one preferred embodiment of the present disclosure has been expressed using specific terms and devices, but those skilled in the art will readily appreciate that the specific examples are for illustrative purposes only and should not limit the scope of the invention which is defined by the claims which follow thereafter.

Throughout this application, various references or publications are cited. Disclosures of these references or publications in their entireties are hereby incorporated by reference into this application in order to more fully describe the state of the art to which this invention pertains. It is to be noted that the transitional term “comprising”, which is synonymous with “including”, “containing” or “characterized by”, is inclusive or open--ended and does not exclude additional, un-recited elements or method steps.

What is claimed is:

1. An energy management system comprising (a) a first power measurement device comprising (1) a plug, (2) one or more power measurement module, (3) one or more AC sockets each of which is coupled with an AC switch, (4) one or more communication modules and (5) a microcontroller, wherein said microcontroller controls the AC switches;
(b) a second power measurement device comprising a plug, a docking space and one or more detachable communication devices, wherein said detachable communication device comprises a microcontroller, one or more communication modules, charging circuitry and battery; and
(c) one or more computing devices, wherein said computing device comprises a software for analyzing energy consumption measurement and providing control instructions for controlling the energy consumption of the AC sockets,
wherein energy consumption from the AC sockets are measured by the first power measurement device and communicated to the computing devices via the communication device of the second power measurement device, wherein control instructions from the computing devices are communicated to the microcontroller in the first power measurement device via the communication device of the second power measurement device.

2. The energy management system of claim 1, wherein the first and second power measurement devices are combined in a single device. The energy management system of claim 1, wherein said. AC sockets further comprise a surge arrestor failure detection scheme so that a remote user could be notified when the arrestor protection has been failed or tripped.

4. The energy management system of claim 1, wherein said detachable communication device could operate on battery when separated from the second power measurement device.

5. The energy management system of claim 1, wherein the communication device of the second power measurement device communicates wirelessly with said computing device using Wi-Fi.

6. The energy management system of claim 5, wherein the communication device of the second power measurement device is capable of operating under Wi-Fi in both infrastructure and ad-hoc modes.

7. The energy management system of claim 6, wherein under ad-hoc mode, the computing device can communicate with the communication device of the second power measurement device from anywhere in the world having internet connection.

8. The energy management system of claim 1, wherein said second power measurement device communicates wirelessly with the first power measurement device using Z-Wave or ZigBee wireless communication.

9. The energy management system of claim 1, wherein the computing device is selected from the group consisting of a smart phone, a tablet computer, a desktop computer or a notebook computer.

10. The energy management system of claim 1, wherein the computing device can store the energy consumption measurement data from each AC socket in the system.

11. The energy management system of claim 1, wherein each of said AC sockets further comprises a mechanical or optical plug detection mechanism so that a user would be notified through said software when said sockets are plugged or unplugged.

12. A method for energy management, comprising the steps:
a. placing the first and second power measurement devices from one or more of the energy management systems of claim 1 at desired locations;
b. plugging a plurality of electrical appliances into the AC sockets in the energy management systems;
c. connecting the first power measurement device, the second power measurement device and the computing device wirelessly; and
d. designating the electrical appliances as master electrical appliances or peripheral electrical appliances, wherein the peripheral electrical appliances are controlled according to energy consumption of the master electrical appliances.

13. The method of claim 12, wherein the first power measurement device and second power measurement device are or are not placed at a same location.

14. The method of claim 12, wherein said master electrical appliances and peripheral electrical appliances are or are not plugged into the AC sockets of the same first power measurement device.

15. The method of claim 12, wherein the master electrical appliances and peripheral electrical appliances are or are not plugged into the AC sockets in the same energy management system.

16. The method of claim 12, wherein the peripheral electrical appliances are turned off when the energy consumption of a master electrical appliance is lower than its operational need.

17. The method of claim 12, wherein the peripheral electrical appliances are automatically turned on when the energy consumption of a master electrical appliance is at its operational need.

18. The method of claim 12, wherein step (c) further comprises detaching the detachable communication device from the second power measurement device and placing it at a location which bridges the wireless connection.
